(19) United States
(12) Patent Application Publication
(10) Pub. No.: US 2008/0004870 A1
(43) Pub. Date: Jan. 3, 2008

(54) Method of detecting for activating a temporal noise shaping process in coding audio signals

(76) Inventors: Chi-min Liu, Hsinchu City (TW); Wen-chieh Lee, Taoyuan City (TW); Tzu-wen Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/477,355

(22) Filed: Jun. 30, 2006

(51) Int. Cl. G10L 19/00

(52) U.S. Cl. 704/219

(57) ABSTRACT

A method of detecting for activating a temporal noise shaping process in coding audio signals comprises the steps of receiving continuous audio signals; computing a perceptual entropy value of each audio signal; comparing the perceptual entropy value with a threshold according to a discriminative condition; and activating temporal noise shaping process when a corresponding result is set true.

### FIELD OF THE INVENTION

The present invention relates to a method for coding audio signals, and in particular to a method of detecting for activating a temporal noise shaping (TNS) process for the advanced audio coding (ACC).

### BACKGROUND OF THE INVENTION

During the last several years coding audio signals have been developed to store of high quality audio signals commonly used on a conventional compact disc medium (CD). Such coders exploit the irrelevancy contained in an audio signal due to the limitations of the human auditory system by coding the signal with only so much accuracy as is necessary to result in a perceptually indistinguishable reconstructed (i.e., decoded) signal. Standards have been established, such as MPEG-1 Layer3, MPEG-2 AAC and MPEG-4 AAC.

In MPEG2/4 AAC coding standard can provides more flexibility to reduce the channel irrelevancy and redundancy for increasing coding quality. Temporal noise shaping has been defined in MPEG2/4 AAC to ease the pre-echo noise caused by attack signals. The process, which is especially important for the MPEG2/4 Low Delay AAC due to the absence of window switching mechanism, can shape and control quantization noise spread to improve the quality under bit rate constraint. Although the TNS process can shape and control the quantization noise spread to improve the signals quality, the TNS will introduce three artifacts. The three artifacts should be carefully controlled when applying the TNS.

The first artifact is similar to the Gibbs phenomenon which has high noise level occurring at the edge of the attack signal. Refer to FIG. 1A, FIG. 1B and FIG. 1C, the FIG. 1A is a wave diagram shown the original signals of the prior art, the FIG. 1B is a wave diagram shown decoded signals without TNS from FIG. 1A and FIG. 1C is a wave diagram shown decoded signals with TNS from FIG. 1A. We can find that the noise around the attacking time interval is amplified after the TNS is applied although the pre-echo is reduced in general. The noise may not be very sensitive to the human auditory system if the noise is controlled to be localized around the attacking time due to the pre-echo masking effect.

The second effect is the time domain aliasing noise which has unusual noise at a distance from the attack time frame. Refer to FIG. 2A, FIG. 2B, FIG. 3B, FIG. 3A, FIG. 3B and FIG. 3C, wherein FIG. 2A is a wave diagram shown the original signals, FIG. 2B is a wave diagram shown decoded signals without TNS from FIG. 2A, FIG. 2C is a wave diagram shown decoded signals with TNS from FIG. 2A, FIG. 3A is a wave diagram shown another original signals, FIG. 3B is a wave diagram shown another decoded signals without TNS from FIG. 3A and FIG. 3C is a wave diagram shown another decoded signals with TNS from FIG. 3A. The reconstruction error is injected into time domain signal which cannot be cancelled in the overlap-add procedure. The error is mirrored to both the right and left half of the attack signals as illustrated in FIG. 2C and FIG. 3C, FIG. 2C shows that the artifact emerges before the attack signal and FIG. 3C shows that the artifact emerges behind the attack signal.

The third is the noise spreading with the TNS filter orders. In general, the coding gain increases with the order of the prediction filter. Hence, the quantization noise may be considered to shape better with the increase of filter order. Refer to FIG. 4A, FIG. 4B and FIG. 4C, FIG. 4A is a wave diagram shown the quantization noise without TNS, FIG. 4B is a wave diagram shown the quantization noise of order 3 and FIG. 4C is a wave diagram shown the quantization noise of order 12. The noise around the attack signal and the aliasing noise increases with the filter order.

FIG. 5 is a TNS flowchart of MPEG-4 AAC. The TNS module receives some spectral coefficients for some frequency ranges to produce a prediction residual signal, which comprises the steps of:

Step S1: obtaining some reflection coefficients and a coding gain by a Levinson-Durbin Recursion method;

Step S2: comparing the coding gain with a constant which is set 1.4 in the MPEG standard and activating a TNS process when the coding gain is higher than the constant;

Step S3: quantizing some reflection coefficients;

Step S4: truncating some reflection coefficients to reduce compute cost;

Step S5: stepping up compute some prediction coefficients and sending the prediction coefficients to a TNS filter; and

Step S6: outputting a prediction residual signal.

There are three problems associated with the detection mechanism. First, the coding gain can not reflect the injection of the above three artifacts. Second, the activating mechanism based on the coding gain directly leads to computing overhead from the TNS filtering. Furthermore, the above-mentioned method needs to compute the Levinson-Durbin method for each audio signal. Hence, the cost is highly.

### SUMMARY OF THE INVENTION

It is an object of the present invention to provide a method of detecting for activating a temporal noise shaping process in coding audio signals, which presents a detection mechanism based on a perceptual entropy for reducing to activate temporal noise shaping process in a unnecessary situation and leading to merit in increasing shaping noise quality, if possible, no audible signal distortions.

It is another object of the present invention to provide an efficient method for leading to merit in complexity, which compares the perceptual entropy value with the threshold according to a discriminative condition and activates temporal noise shaping process when a corresponding result is set true so as to avoid computing the Levinson-Durbin method for each audio signal.

In conclusion, the present invention is related to an method of detecting for activating a temporal noise shaping process in coding audio signals comprises the steps of receiving continuous audio signals; computing the perceptual entropy value of each audio signal; comparing the perceptual entropy value with the threshold according to the discriminative condition, Wherein the discriminative condition is used to detect whether the N^{th} audio signal is an attack signal or not. When the (N-1)^{th} audio signal is like quiet sound and the N^{th} audio signal is like drastic sound, the N^{th} audio signal is sure to an attack signal and then the corresponding result is set true; and activating temporal noise shaping process when the corresponding result is set true. The method can reduce a lot of attack signals and pre-echo problems and lead to merits in both quality and complexity.

It is to be understood that both the foregoing general description and the following detailed description are exemplary, and are intended to provide further explanation of the invention as claimed.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1A is a wave diagram shown the original signals of the prior art;

FIG. 1B is a wave diagram shown decoded signals without TNS from FIG. 1A;

FIG. 1C is a wave diagram shown decoded signals with TNS from FIG. 1A;

FIG. 2A is a wave diagram shown the original signals;

FIG. 2B is a wave diagram shown decoded signals without TNS from FIG. 2A;

FIG. 2C is a wave diagram shown decoded signals with TNS from FIG. 2A;

FIG. 3A is a wave diagram shown another original signals;

FIG. 3B is a wave diagram shown another decoded signals without TNS from FIG. 3A;

FIG. 3C is a wave diagram shown another decoded signals with TNS from FIG. 3A;

FIG. 4A is a wave diagram shown the quantization noise without TNS;

FIG. 4B is a wave diagram shown the quantization noise of order 3;

FIG. 4C is a wave diagram shown the quantization noise of order 12;

FIG. 5 is a TNS flowchart of MPEG-4 AAC;

FIG. 6 is a block diagram of an ACC coding;

FIG. 7 is a flowchart of activating the TNS process of the present invention;

FIG. 8 is a flowchart of the TNS process of the present invention;

FIG. 9A is an illustrated view of the fifteen test songs for quality evaluation; and

FIG. 9B is an illustrated view of Objective test on the three methods.

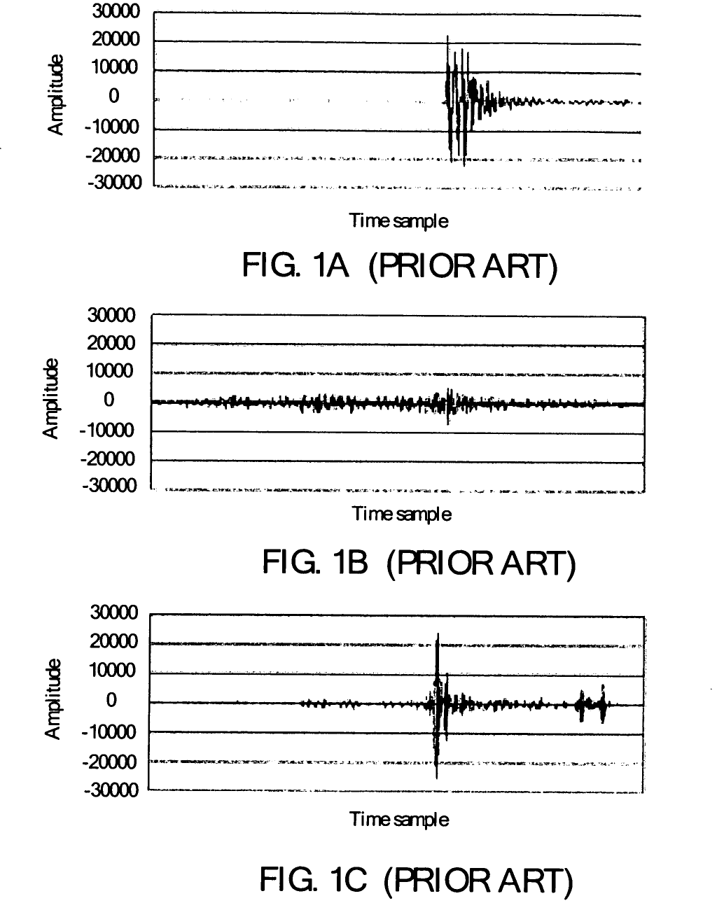

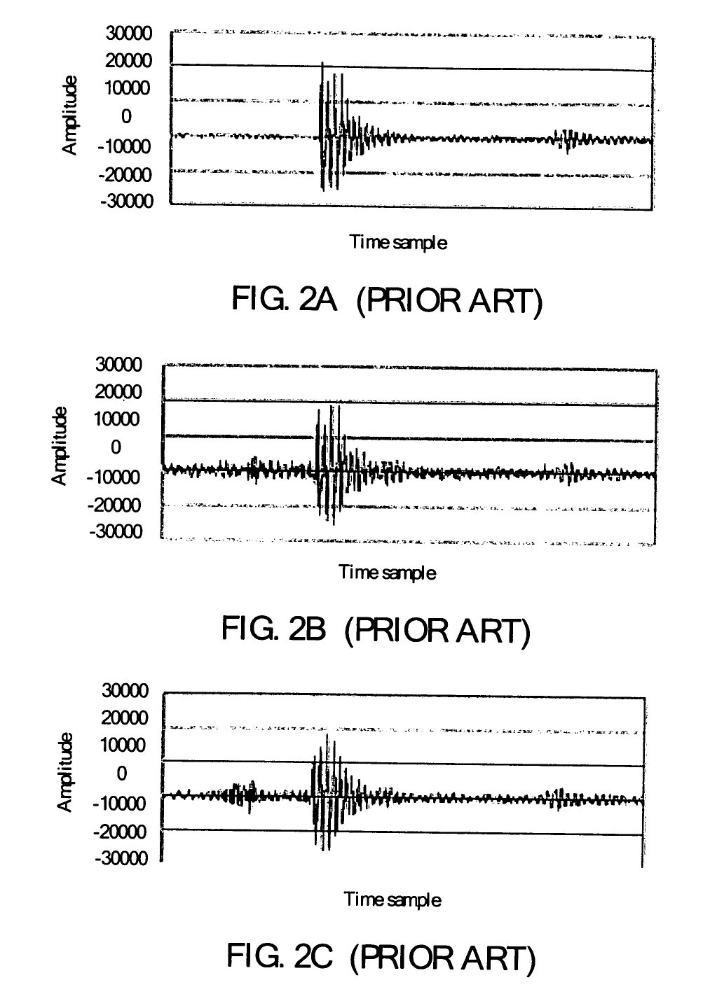

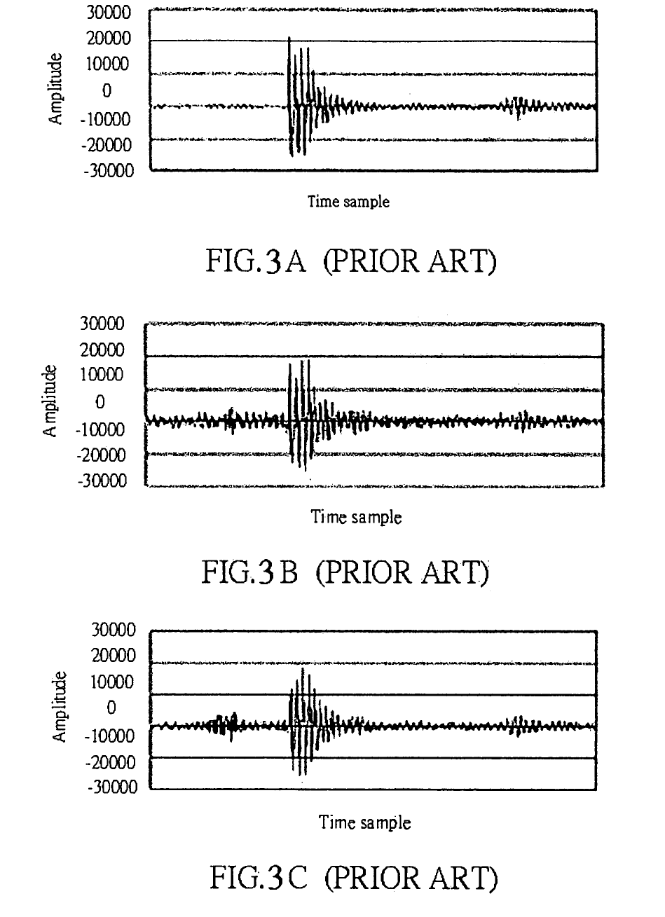

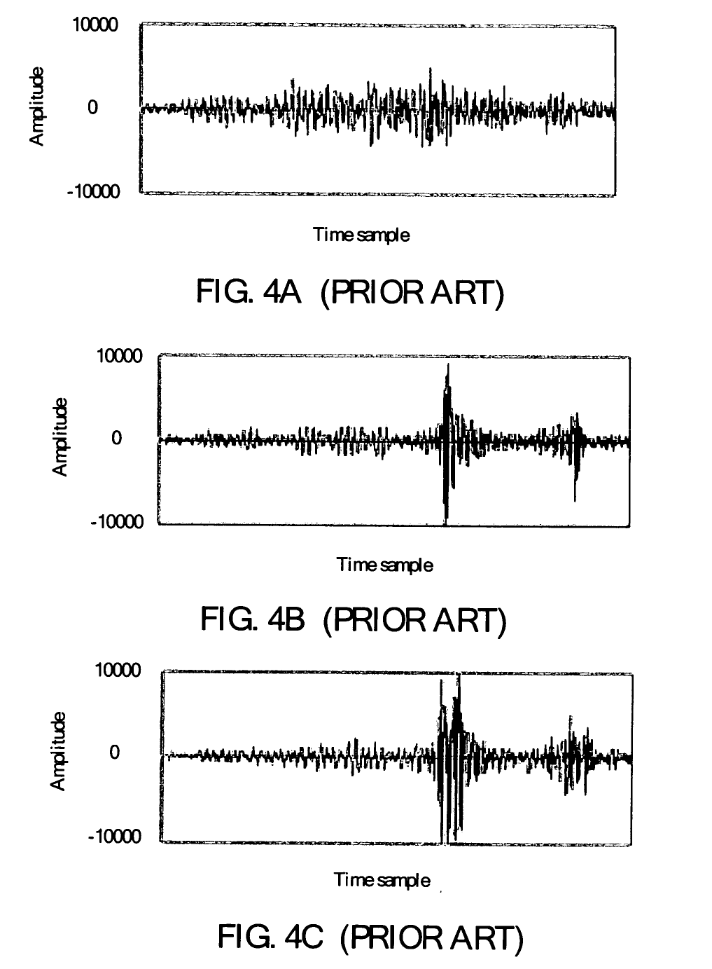

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

FIG. 6 is a block diagram of an ACC coding. The audio signals are segmented into overlapped blocks and transformed into frequency domain through an analysis filter bank 10. A psychoacoustic module 20 analyzes some contents of the audio signal and calculates the associated perceptual resolution on the human hearing systems and some parameters and then sends some parameters to a TNS module 30 and bit Allocation 40, respectively. The TNS module 30 decides the situation to activate TNS process according to the parameter. According to the perceptual resolution and the available bits, the bit allocation 40 decides the suitable quantization manner to fit the bit rate and sends a corresponding result to a quantization/coding module 50. The quantization/coding module 50 quantizes and codes the audio signals which receives from the TNS module 30 and sends a corresponding result to a bitstream multiplexer 60. The bitstream multiplexer receives the coding audio signals from the quantization/coding module 50 and produces coded audio stream.

In order to resolve these disadvantages mentioned above, the efficient activating criterion through PE (Perceptual Entropy) is proposed in present invention. The PE is defined as:

$$PE = {\sum }_{b} {BW}_{b} * log ( \frac{{E}_{b} + 1}{{Masking}_{b}} ) \qquad ( 1 )$$

where b is the index of the threshold calculation partition, BW_{b} is the number of the frequency lines in partition b, E_{b} is the sum of the energy in partition b and Masking_{b} is the masking threshold in partition b. The masking threshold Maasking_{b} is defined as:

Masking_{b}=max(qthr_{b}, min(nb_{b}, nb_{—}l_{b}*repelev)) (2)

where qthr_{b} is the threshold in quiet, nb_{b} is the threshold of partition b, nb_l_{b} is the threshold of partition b for the last block and rpelev is set to ‘1’ for short blocks and ‘2’ for long blocks. From (1) and (2), when the (N-1)^{th} signal is like quiet sound and the N^{th} signal is an attack signal, the Masking_{b} of the N^{th} signal is the small value, nb_l_{b} * repelev, not nb_{b}. The corresponding PE is high. It means that the N^{th} input signal is an attack signal. Besides, the PE value of each audio signal has been computed in the psychoacoustic model 20. The method can avoid computing the Levinson-Durbin method for each audio signal.

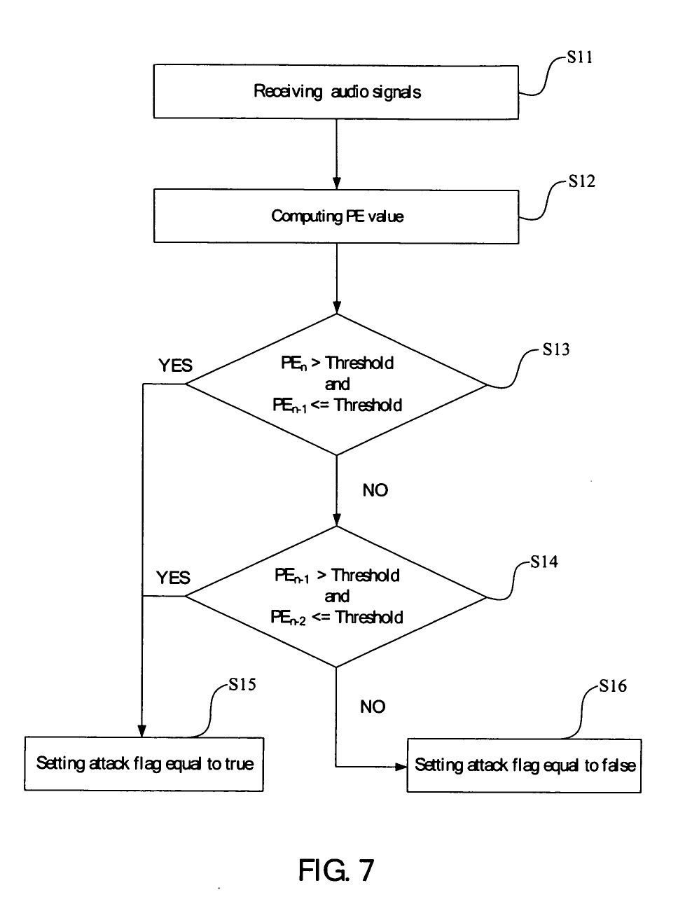

FIG. 7 is a flowchart of activating the TNS process of the present invention which comprises the steps of:

Step S11: sending continuous audio signals to a psychoacoustic module;

Step S12: computing a perceptual entropy (PE) value of each audio signal;

Step S13: comparing the PE values of the N^{th} audio signal and (N-1)^{th} audio signal with a threshold respectively and then executing Step S15 when the PE value of the N^{th} audio signal is higher than the threshold and the PE value of the (N-1)^{th} audio signal is lower than the threshold or equal to the threshold otherwise the process executes Step S14;

Step S14: compares the PE value of the (N-1)^{th} audio signal is higher than the threshold and the PE value of the (N-2)^{th} audio signal is lower than the threshold or equal to the threshold and then executing Step S15 when the PE value of the (N-1)^{th} audio signal is higher than the threshold and the PE value of the (N-2)^{th} audio signal is lower than the threshold or equal to the threshold otherwise the process executes Step S16;

Step S15: setting a value of an attack flag be true; and

Step S16: setting a value of an attack flag be false.

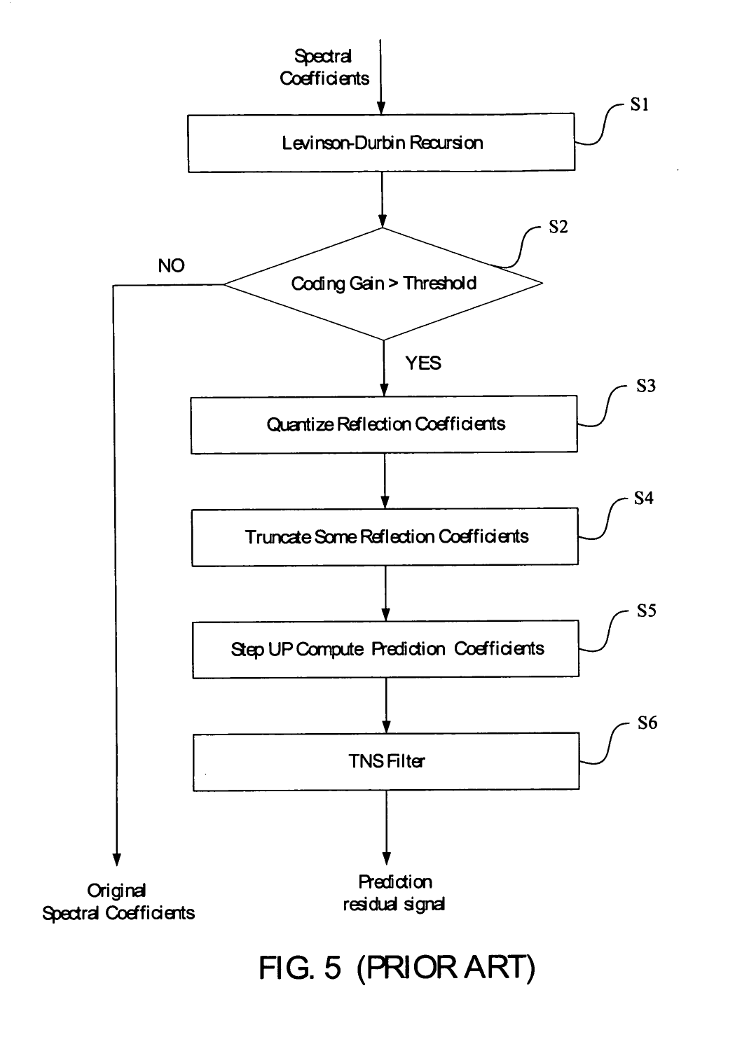

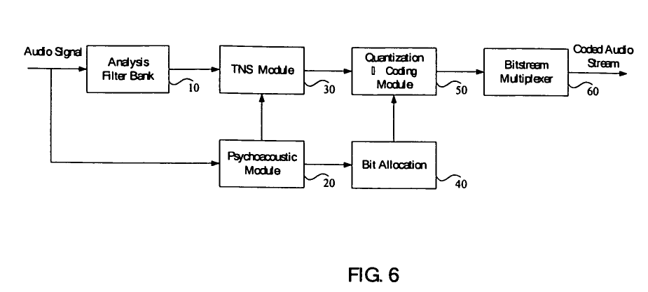

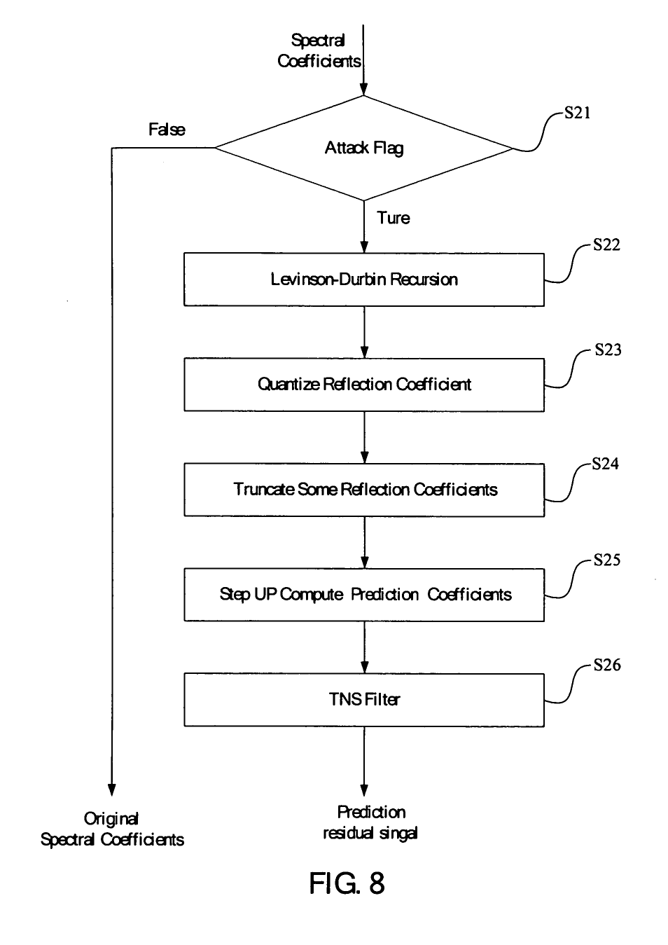

FIG. 8 is a flowchart of the TNS process of the present invention. The TNS module receives some spectral coefficients and executes step S21 to judge the value of an attack flag. When the value of the attack flag is true, the process execute steps S22 to S26. The steps S22˜S26 are as same as the step S1 and S3˜S6 of the FIG. 5. Otherwise, the process outputs some original spectral coefficients.

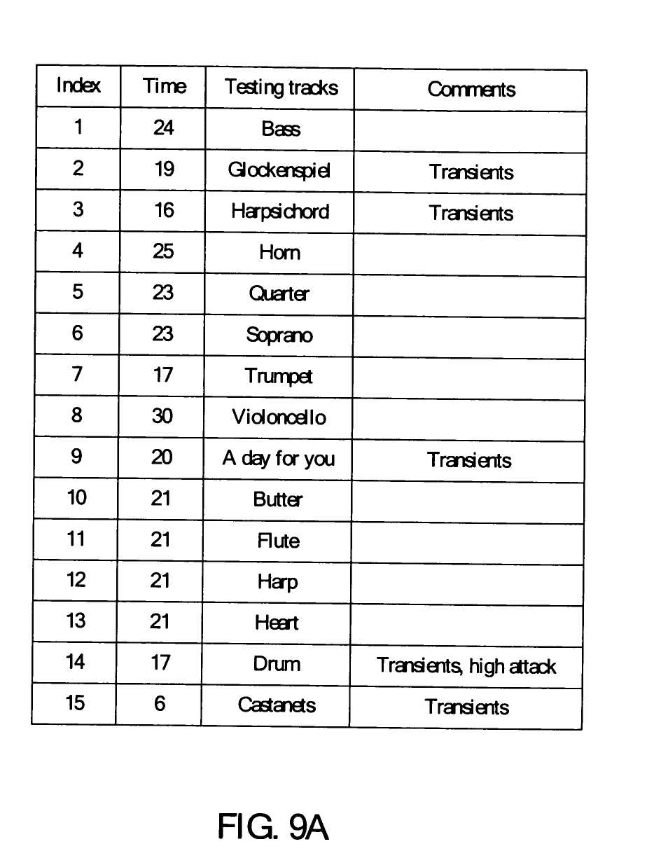

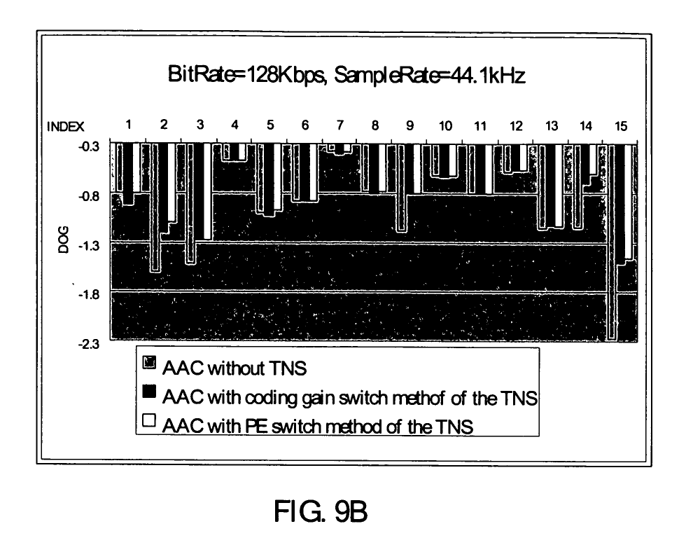

FIG. 9A is an illustrated view of the fifteen test songs for quality evaluation and FIG. 9B is an illustrated view of Objective test on the three methods. FIG. 9A illustrates the objective measurement of the two different activating methods of TNS coding based on the system (ITU Radiocommunication Study Group 6, “DRAFT REVISION TO RECOMMENDDATION ITU-R BS.1387—Method for objective measurements of perceived audio quality”.) And the NCTU-AAC codec, an implementation of MPEG-4 AAC codec. Here the present invention has adopted for objective quality measure the PEAQ (perceptual evaluation of audio quality) which is the recommendation system by ITU-R Task Group 10/4.

The objective difference grade (ODG) is the output variable from the objective measurement method. The ODG values should range from 0 to −4, where 0 corresponds to an imperceptible impairment and −4 to impairment judged as very annoying. The PEAQ has been widely used to measure the compression technique due to the capability to detect perceptual difference sensible by human hearing systems. The 15 songs used are listed in FIG. 9A. AAC without TNS, AAC with TNS based on the coding gain method and AAC with TNS based on PE method are adopted for comparison. The TNS based on PE has a quality better than the TNS based on coding gain. The two different TNS activating methods have a great improvement on the attack audio tracks 2, 3, 9, 14 and 15 for both objective and subjective tests. However, in the tracks indexed by 1, 5, and 8, the coding gain method gets an even worse ODG than the coded songs without the TNS due to artifacts introduced by TNS mentioned above.

For the coding gain method, each of the input audio signal must conduct the TNS module, the complexity is O(k²), where k is the number of the reflections coefficients. Therefore, the whole complexity of the TNS method is O(Nk²), where N is the number of input audio signal. However, with the PE method, TNS module is applied only when attack flag is active. The complexity of is reduced to O(nk²), where n is the number of the attack audio signal in the entire audio signals. For most tracks, the number of audio signals that attack flag is active may be only a small portion less than 1%. Hence, the complexity is highly reduced.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed is:

1. A method of detecting for activating a temporal noise shaping process in coding audio signals, comprising the steps of:
receiving continuous audio signals;
computing a perceptual entropy (PE) value of each audio signal; and
comparing the PE values of the N^{th} audio signal and (N-1)^{th} audio signal with a threshold respectively;
wherein activating a temporal noise shaping process when the PE value of the N^{th} audio signal is higher than the threshold and the PE value of the (N-1)^{th} audio signal is lower than the threshold or equal to the threshold.

2. The method of claim 1, wherein further comprising a step after comparing the PE value, which comprises the steps of:
setting a value of an attack flag be true when the PE value of the N^{th} audio signal is higher than the threshold and the PE value of the (N-1)^{th} audio signal is lower than the threshold or equal to the threshold otherwise the value of the attack flag is set false; and
activating the temporal noise shaping process when the attack flag is true.

3. The method of claim 1, wherein further comprising a step after comparing the PE value, which compares the PE values of the (N-1)^{th} audio signal and the (N-2)^{th} audio signal with the threshold when the PE value of the N^{th} audio signal lower the threshold or the PE value of the (N-1)^{th} signal higher than the threshold.

4. The method of claim 3, wherein further comprising a step after comparing the PE value, which comprises the steps of:
setting a value of an attack flag be true when the PE value of the (N-1)^{th} audio signal is higher than the threshold and the PE value of the (N-2)^{th} audio signal is lower than the threshold or equal to the threshold otherwise the attack flag is set false; and
activating the temporal noise shaping process when the attack flag is true.

5. The method of claim 1, wherein the PE value is computed by the psychoacoustic model.

6. The method of claim 1 wherein the audio signal comprises speech.

7. The method of claim 1 wherein the audio signal comprises music.

8. The method of claim 1, wherein the threshold is provided by the psychoacoustic model.
